(19) United States
(12) Patent Application Publication
(10) Pub. No.: US 2016/0369833 A1
(43) Pub. Date: Dec. 22, 2016

(54) UNOCLIP, a hanging hook for secure fastening of articles of personal use.

(71) Applicant: Helder Dagot Lamarque, Algueirao-Mem Martins (PT)

(72) Inventor: Helder Dagot Lamarque, Algueirao-Mem Martins (PT)

(21) Appl. No.: 14/745,443

(22) Filed: Jun. 21, 2015

(51) Int. Cl. F16B 45/02; F16M 13/02

(52) U.S. Cl. CPC F16B 45/02; F16M 13/02

(57) ABSTRACT

The UNOCLIP is a spring activated hook assembly for securely retaining articles of dress or the like intended for use by persons disadvantaged by loss of sight or maneuverability and require that a hung item remain on the hanger hook. Also the UNOCLIP is useful in mobile platforms that need to have items retained on its holders. The hanging item is placed onto or removed from the hook by simply sweeping aside a retaining swinging arm that is pivoted on a torsion spring securely mounted to the hook assembly base. The tensioned swinging arm secures items hung on the hook by seeking its neutral untensioned position and thereby either pressure retains or encloses the item placed on the hook.

### CROSS REFERENCE TO RELATED PATENT

Norwegian Patent 321019 i, UNICLIP, Mar. 29, 2004 Proposed Classes: International A47G 25/06//Clothes hooks. U.S. 223//Apparel Apparatus

### FEDERALLY SPONSORED RESEARCH

Not Applicable

### JOINT RESEARCH PARTIES

None.

### SEQUENCE LISTING

Not Applicable

### PRIOR DISCLOSURES

Applicant is the Inventor of the prior parent patent cross-referenced above.

### BACKGROUND OF THE INVENTION

Many devices hang clothing and other articles of wear. Hardware suppliers have decorative hooks that suit most personal needs. However, a universal retaining hook that secures the apparel to its hold is sorely needed by the handicapped community of Alzheimer and blind disadvantaged and all who find it difficult to bend-reach to the floor. It is also a handy item for anyone who has put a towel or a robe on a clothing hook only to find it on the floor. This is particularly appropriate aboard boats, land trailers and airplanes. Indeed a hook to hold an article of clothing should indeed retain the item until it is manually removed.

Spring clasping hooks exist in the public domain that do enclose ringlets that hold strapping and perhaps clothing but have a limited retaining area defined by the distance the spring can be depressed. The applicant had patented a clip under Norwegian patent 321019 i, that did swing in one direction but that device found limited market acceptance. The inventor spent years on improving the concept and has devised an improved swing clip that has more versatility than the prior UNICLIP patent.

The inventor has since improved his original concept to create a new kind of retaining clip for articles of wear that features a torsion spring that permits free motion of a pivoting swinging arm in a horizontal plane perpendicular to the hook that retains the article of wear or use.

### DESCRIPTION OF THE RELATED ART

The UNICLIP, Norwegian patent #321019, was intended to provide a positive retaining hook for articles of clothing and such for the handicapped who found retrieving an article from the floor a challenge. These handicaps include those who had difficulty in bending or the visually disadvantaged. The hook also found other uses where a retention of an article must be positive but that retention must be also easily removed. Such uses include boat cleats or a clothing hooks in a moving platform such as a vehicle trailer, boat or airplane. This initial UNICLIP hook was peg shaped and had a limited motion on the retaining mechanism. It received very limited market response and fell into the public domain.

The inventor has since improved his original concept to create a new versatile hook that features a torsion spring to permit free motion of a swinging arm in a horizontal plane perpendicular to the hook that retains the article of wear or use.

There is currently a plethora of designer clothing hooks in the public domain that are readily available in a variety of styles. The popular clothing clip is a spring closure that is restricted to being depressed in a limited direction and aperture.

The within disclosed hook device, hereinafter “UNOCLIP”, is intended to positively retain any item placed on or within the hooking appendage. This may be a rope, a leash for a seeing eye dog or a article of clothing or other fabric. It has applicable use on boats or docks for retaining lines. It is particularly useful in hospitals or factories or recreation centers and places of entertainment where space must be conserved and generally available open hooks are not positive retaining enough to assure that any article that is placed on the hook will be there when needed and easily removed.

### BRIEF SUMMARY OF THE INVENTION

The invention, hereinafter called “UNOCLIP” is a closure-hooking device whereby the closure is assured by a torsion spring returning a swinging arm to a neutral alignment position where the spring is at its zero stress torque. In seeking that home alignment position the swing arm gently retains whatever is placed on the hook. If the hung item sits wholly within the hook (as perhaps a loop tag on the clothing), the neutral position is the zero alignment position where the retaining spring is not under any torque tension and the end of the swing arm is closed against the hook. The swing arm can be deflected in a clockwise, counter-clockwise or depressed to assure an adequate aperture to hold the intended article(s).

To remove any item from the retaining hook, a gentle tug will permit the article to slide off the hook or light finger pressure will result in the swing arm to retract so the article may easily be lifted off.

### BRIEF DESCRIPTION OF THE DRAWINGS

FIG. 1. Several perspective views of the UNOCLIP assembly is a perspective detailed view of the best current practice of the invention shown at an alignment position in the several views of

FIG. 1A, angular perspective;

FIG. 1B, lower plan;

FIG. 1C, side plan, and

FIG. 1D, top plan.

FIG. 2 Perspective view of a blow up of the UNOCLIP device assembly shows the component integral parts.

FIG. 3. Details of the integral parts of the UNICLIP assembly in the several views of

FIG. 3A, a midline sectional cut;

FIG. 3B, the upper, side and under plan of the Swing Arm;

FIG. 3C, the top plan of the hook body.

FIG. 4, The functional characteristics of the UNOCLIP shows views of the swing motions of the Swing Arm of

FIG. 4A as a counter-clockwise swing;

FIG. 4B as a clockwise swing and

FIG. 4C as a mid-sectional cut of a depressed swing arm.

### DETAILED DESCRIPTION OF THE EMBODIMENT

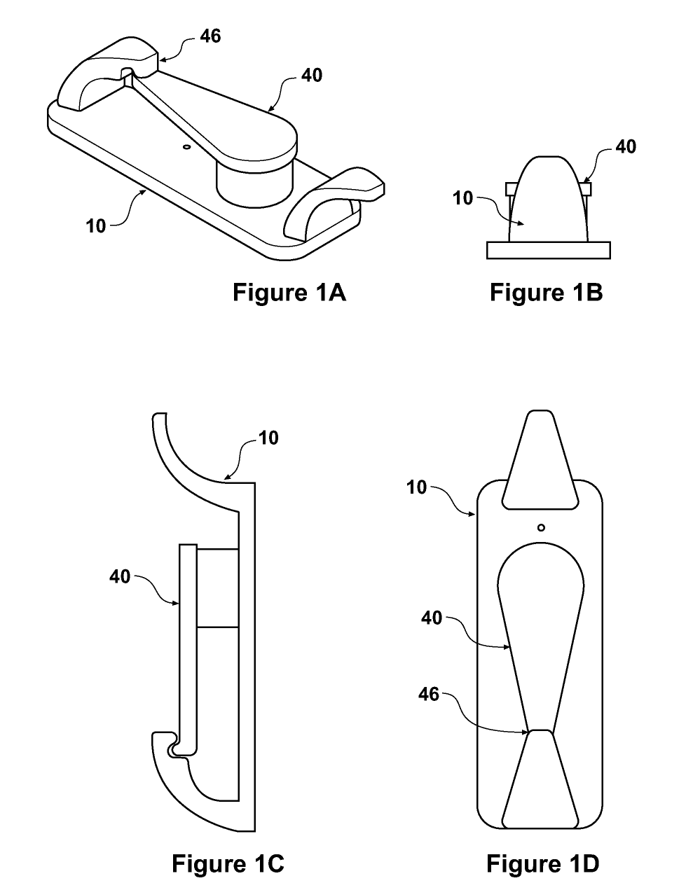

FIG. 1 shows the various physical perspective views of the best current practice employed in the UNOCLIP assembly. These perspective views show the integral components of a HOOK BODY 10 and a SWING ARM 40 from an angle in View 1A, plan detail of the lower extremity in View 1B, side plan detail in View 1C and top plan detail in View 1D of the UNOCLIP. All views show the UNOCLIP in an ALIGNED POSITION 46 of the SWING ARM 40 wherein the contained torsion spring is in zero tension.

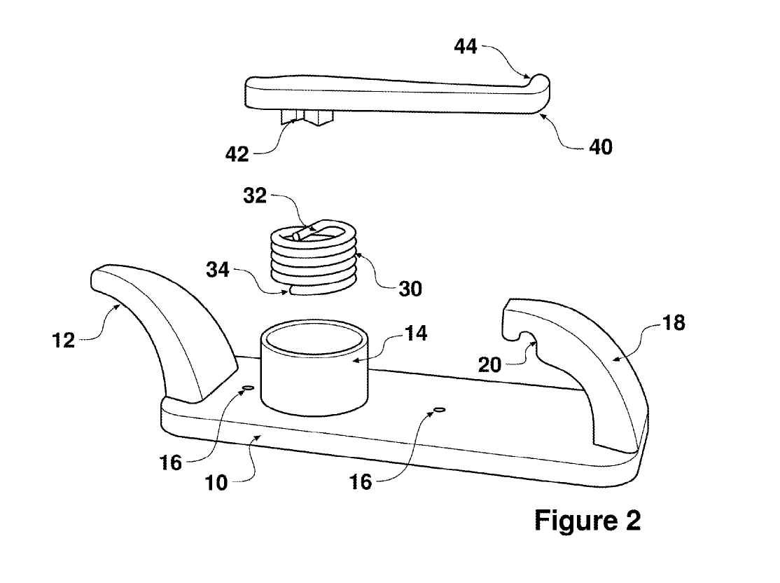

FIG. 2, a blow-up, shows the details of the three major integral components that comprise this simple retaining hook system. These are the HOOK BODY 10, a TORSION SPRING 30, and the SWING ARM 40. The SWING ARM 40 mates with a TOP GRASP COIL 32 on the TORSION SPRING 30 by means of a SWING ARM GRASP BLOCK 42 located on the underside of the SWING ARM 40 and then a BOTTOM GRASP COIL 34 of the TORSION SPRING 30 then mates with the HOOK BODY 10 by a similar arrangement located within a FERRULE 14 which is a part of the HOOK BODY 10. The FERRULE 14 encloses the TORSION SPRING 30 and is dimensioned to assure the SWING ARM 40 returns to the RETAINING HOOK 18. The location of the FERRULE 14 also defines the pivoting point of the SWING ARM 40. Furthermore, the alignment of the geometries of TOP GRASP COIL 32 and the BOTTOM GRASP COIL 34 which are inserted into the respective grasp blocks on the HOOK BODY 10 and SWING ARM 40 are such that a MALE GUIDE 44 on the SWING ARM 40 returns to a zero tensioned alignment position (the home position) in a FEMALE GUIDE 20 in the RETAINING HOOK 18. The MALE GUIDE 44 on the SWING ARM 40 also acts as a claw in retaining articles hung over the RETAINING HOOK 18.

The UNOCLIP may be joined to a surface by the use of screws or other joining means through the MOUNTING HOLES 16, though adhesive materials may also suffice. The UNOCLIP also has an auxiliary OPEN HOOK 12 located on the upper extremity of the HOOK BODY 10 as a convenience for articles that need no retaining hold.

In use, articles of clothing (or the like) may be hung on the RETAINING HOOK 18 of the assembled UNOCLIP by pushing the SWING ARM 40 aside. The TORSION SPRING 30 then pivots the SWING ARM 40 towards the home alignment position. If the item placed on the RETAINING HOOK 18 fits within the bend of the hook, the MALE GUIDE 44 on the SWING ARM 40 returns to the untensioned home alignment position within the FEMALE GUIDE 20 on the HOOK BODY 10. If the items fit over the forward edge of the hook, the SWING ARM 40 returns to a tensioned position, whereby the MALE GUIDE 44 on the SWING ARM 40 acts like a claw and pinches the hung article tightly in place, assuring it will not slip off the hook.

Removal of an item just requires a light tug of the item draped on the RETAINING HOOK 18 or pushing or depressing the SWING ARM 40 and lifting an enclosed item off the RETAINING HOOK 18.

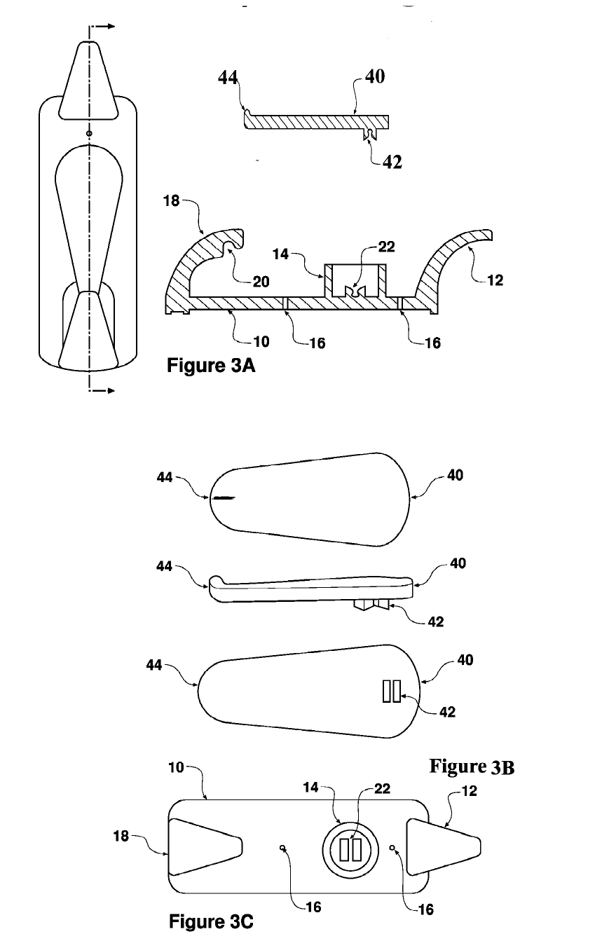

FIG. 3. Details of the integral parts of the UNOCLIP assembly, further shows more parts of the UNOCLIP in a section cut 3A as well as relevant plan views of the SWING ARM 40 and the HOOK BODY 10. The View 3A is a midline sectional cut that shows a BASE GRASP BLOCK 22 that grasps the bottom coil of the torsion spring that also grasps its top coil to the SWING ARM GRASP BLOCK 42 onto the torsion spring inserted within the FERRULE 14. The FERRULE 14 determines the pivoting point at one extremity of the SWING ARM 40. Also, illustrated is the engaging MALE GUIDE 44 (a claw) and the mating FEMALE GUIDE 20. The objective of this figure is to add clarity to the prior functional description given above.

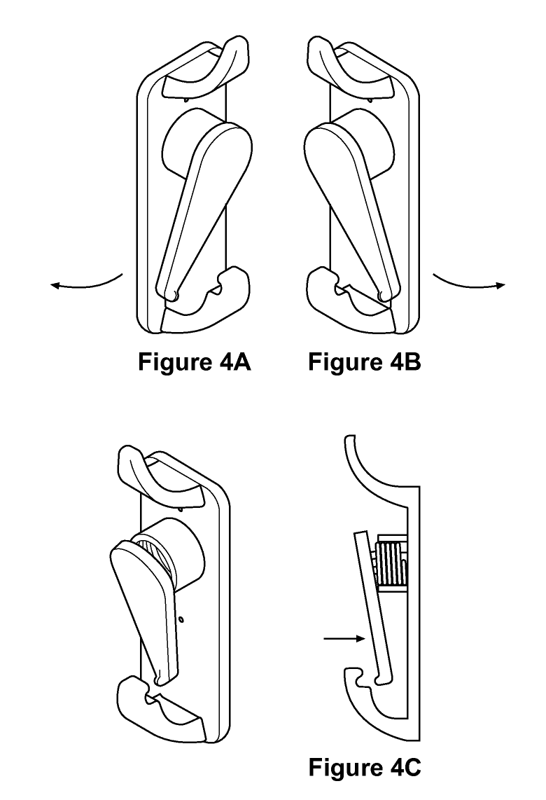

FIG. 4, The functional characteristics of the UNOCLIP is a further illustrative elaboration of the functional description given above. The three views of View 4A, B,and C clearly demonstrate the free horizontal two dimensional motions of the swing arm by a rotation clockwise, counter-clockwise or inward from the zero tensioned alignment position that makes the UNOCLIP a unique item holder that can retain items placed on or within the retaining hook.

The above described component parts is associated with the best current production design of the UNOCLIP and not intended to be limiting.

LEXOGRAPHY TABLE OF SPECIFICATION AND CLAIMS

| | CALL | FIG. | |
|---|---|---|---|
| NAME | OUT | # | Mechanical Description |
| HOOK BODY | 10 | 1 | intergral body of hook(s) |
| OPEN HOOK | 12 | 2 | hook shaped appendage |
| FERRULE | 14 | 2 | tubular alignment device |
| MOUNTING HOLES | 16 | 2 | joining means for |
| | | | surface mounting |
| RETAINING HOOK | 18 | 2 | hook shaped appendage |
| FEMALE GUIDE | 20 | 2 | female alignment guide |
| BASE GRASP BLOCK | 22 | 3 | grasping means to |
| | | | bottom grasp coil |
| TORSION SPRING | 30 | 2 | torsion spring of multiple |
| | | | coils |
| TOP GRASP COIL | 32 | 2 | upper end coil of spring |
| BOTTOM GRASP COIL | 34 | 2 | lower end coil of spring |
| SWING ARM | 40 | 1 | pivoting arm |
| SWING ARM | 42 | 2 | grasping means to top grasp |
| GRASP BLOCK | | | coil |
| MALE GUIDE | 44 | 2 | male alignment guide, claw |
| ALIGNMENT | 46 | 1 | home central zero-tensioned |
| POSITION | | | position |

The inventor claims:

1. Assembling a secure retaining hook for retaining items and having components of a hook body with a lower retaining hook on the one extremity and a upper open hook on the distal extremity of the hook body, a torsion spring of a multiplicity of coils between a top coil and bottom coil, a ferrule for containing the torsion spring and a swing arm with an upper pivoting end and a lower end claw by the processes of
attaching said torsion spring by said bottom coil below said upper hook on said hook body by grasping means
enclosing said torsion spring by said ferrule which is dimensioned in height to the height of the said lower retaining hook on said hook body
attaching said swing arm at its upper pivoting end to said top coil of said torsion spring by an grasping means and
aligning said lower end claw on said swing arm centrally contacting to said retaining lower hook to a alignment position and
joining the above described assembled secure retaining hook assembly to a surface by a joining means.
whereby the swing arm closes-off the retaining lower hook in the alignment position of untensioned spring state but is easily pushed from its untensioned alignment position to hang items which are grasped by the end claw that seeks its alignment position against the retaining lower hook.

2. A secure fastening hook assembly for retaining items hung on it having a hook body, a torsion spring, a ferrule and a swing arm comprising
on said hook body, a open hook on one end of said hook body, a retaining hook on a distal end containing inscribed a female guide means, a hook body grasping means to engage a bottom grasp coil of said torsion spring, said ferrule for containing said torsion spring and enclosing said grasping means where said ferrule creates a pivot point on one end of said swing arm and into said ferrule fits
said torsion spring which grasps said body grasping means at its said lower grasp coil and uniting said hook body to said swing arm by a upper grasp coil of said torsion spring by a swing arm grasping means which sets an alignment position of
said swing arm by a male guide means on a free swinging distal end of said swing arm centrally into said retaining hook by engaging said female guide means
and a surface mounting means for attaching said secure fastening hook assembly to a surface
whereby the surface mounted hook assembly may positively retain items placed upon the retaining hook by pushing the pivoting swing arm aside from its alignment position thereby permitting the swing arm to pinch the item on the retaining hook thereby positively retaining the placed item until manually removed.

3. A grasping means on said assembly of claim 2 further comprising
a solidifying adhesive substance for grasping together said top coil and bottom coil of said torsion spring uniting said hook body to said swing arm in aligned position configuration.

4. A grasping means on said assembly of claim 2 further comprising
a cavity in a base grasp block for a locking grasp to said bottom grasp coil of said torsion spring and a cavity in a swing arm grasp block for a locking grasp to said top grasp coil of said torsion spring uniting said hook body to said swing arm in aligned configuration.

5. A surface mounting means on said hook body as described in claim 2 further comprising
an adhesive material
whereby said assembly is surface mounted.

6. A surface mounting means on said hook body as described in claim 2 further comprising
a plurality of penetrating apertures in said hook body for surface penetrating devices.
